(19) United States
(12) Patent Application Publication
(10) Pub. No.: US 2025/0213058 A1
(43) Pub. Date: Jul. 3, 2025

(54) MASSAGE FACE PILLOW WITH INTERNAL CHANNEL

(71) Applicant: QINGLIN QIU, BROOMFIELD, CO (US)

(72) Inventor: QINGLIN QIU, BROOMFIELD, CO (US)

(21) Appl. No.: 19/054,816

(22) Filed: Feb. 15, 2025

Related U.S. Application Data
(63) Continuation of application No. 18/082,582, filed on Dec. 16, 2022.

(51) Int. Cl. A47G 9/10; A61G 13/00; A61G 13/12

(52) U.S. Cl. CPC A47G 9/1054; A61G 13/009; A61G 13/121; A47G 2009/1018; A61G 2200/325

(57) ABSTRACT

This utility model discloses a massage face pillow with an internal air channel, comprising upper Tier 1 filler made of soft sponge and lower Tier 2 filler made of EPE foam. The upper filler features a face-shaped hole, adapted to fit the human face, while the lower filler includes a corresponding round hole, forming a vertical breathing air channel. A horizontal air channel extends from the vertical air channel to an air outlet at the front edge, enhancing ventilation. This two-layer structure ensures a secure facial fit while optimizing airflow and maintaining a low profile. Designed for massage and beauty treatments, it eliminates the need for an additional face cradle and allows use on massage mats without ventilation holes.

### BACKGROUND OF THE INVENTION

In the current market, traditional massage face pillows used in the clients' prone position require a cradle or a ventilation hole in a massage table. Especially when we develop massage techniques on a soft mat, we cannot use current massage face pillows for client's prone position, because there is no ventilation hole on the massage mat.

### SUMMARY OF THE INVENTION

This invention introduces a massage face pillow with an internal air channel, designed to provide comfortable face support and enhanced breathability while maintaining a low-height pillow, less than 3 inches height. The face pillow is constructed from three primary components:

### A. Upper Tier 1 Filler (2)

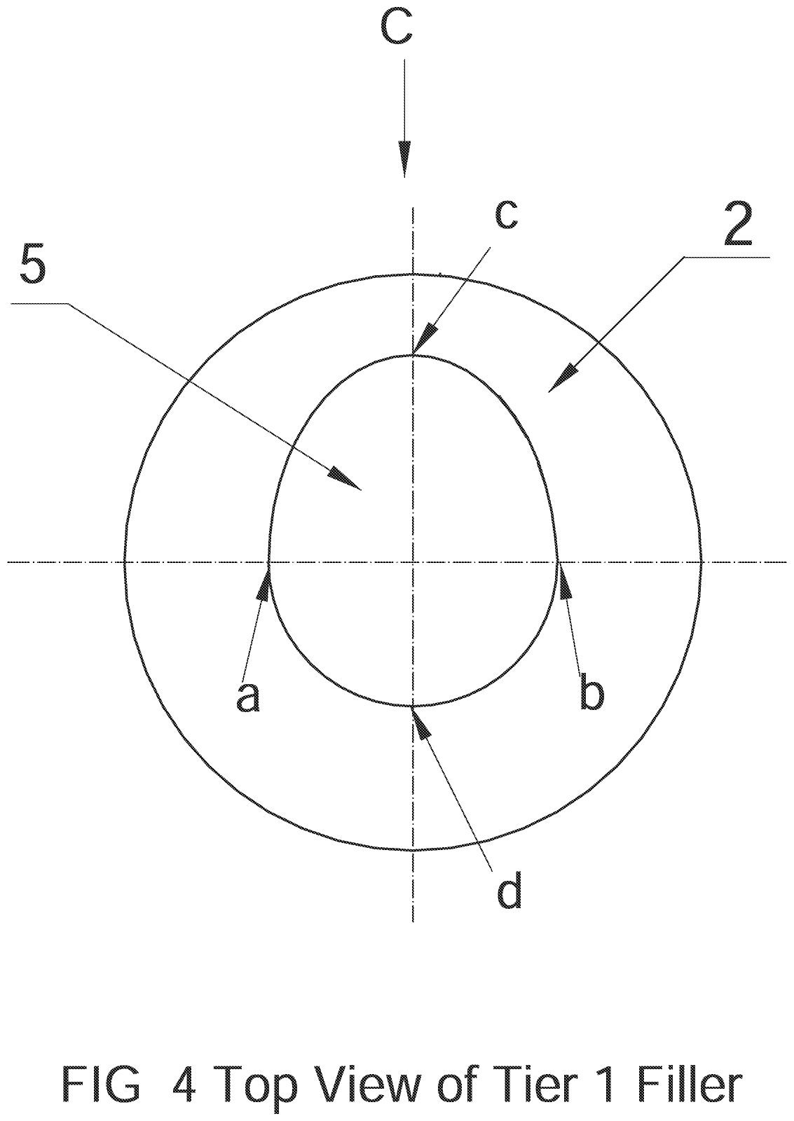

Made of soft sponge material with a density of 25-30 Kg/M3;
Has an approximately 11-inch outside diameter;
Features a face-shaped hole (5) in the center, initially formed as a round hole with 5-inch inner diameter, later modified into a combination of a half round hole (5-inch inner diameter showing a-d-b arc line on FIG. 4) and a half-oval hole (12-inch long diameter, 10-inch short diameter showing a-c-b arc line on FIG. 4) to better conform to the contours of the human face;
The thickness of Tier 1 filler (2) constitutes 50% of the total massage face pillow height, usually about 2.5 to 3.0 inches height.

### B. Lower Tier 2 Filler (3)

Composed of EPE foam material with a density of approximately 45 Kg/m³;
Has an outside diameter identical to Tier 1 Filler (2) for a uniform structure;
Contains a corresponding round hole (4) with a 5-inch inner diameter in the center, aligned with the face-shaped hole (5) in Tier 1 Filler (2) to form a vertical breathing air channel;
The vertical breathing air channel extends to the front edge through a 2.5-inch wide horizontal and rectangular cut-out forming a horizontal breathing air channel (44) in Tier 2 Filler (3), matching its full height, and leading to the air outlet (7) for efficient airflow;
The thickness of Tier 2 Filler (3) accounts for 50% of the total face pillow height, typically ranging between 2.5 to 3.0 inches.

### C. Leather or synthetic leather covering (1)

Tier 1 filler and Tier 2 filler is enclosed within a four-piece leather or synthetic leather covering, which consists of:
1. A bottom round piece (8), which covers the bottom side of the Tier 2 Filler (3), and also sealed the bottom side of the 2.5-inch wide horizontal rectangular air channel (44);
2. A vertical surrounding strip piece (9), featuring a front-facing open 2.5-inch wide rectangular hole at its lower half area that serves as the primary air outlet (7), aligning to the horizontal rectangular air channel (44);
3. A flat ring-shaped piece (10) positioned on the top side of the massage face pillow;
4. A hanging ring-shaped curtain piece (6), covering the inside wall of the face-shaped hole (5) in the upper Tier 1 Filler (2), and its top end connected with the flat ring-shaped piece (10), and its lower end to be glued on the Tier 1 filler.

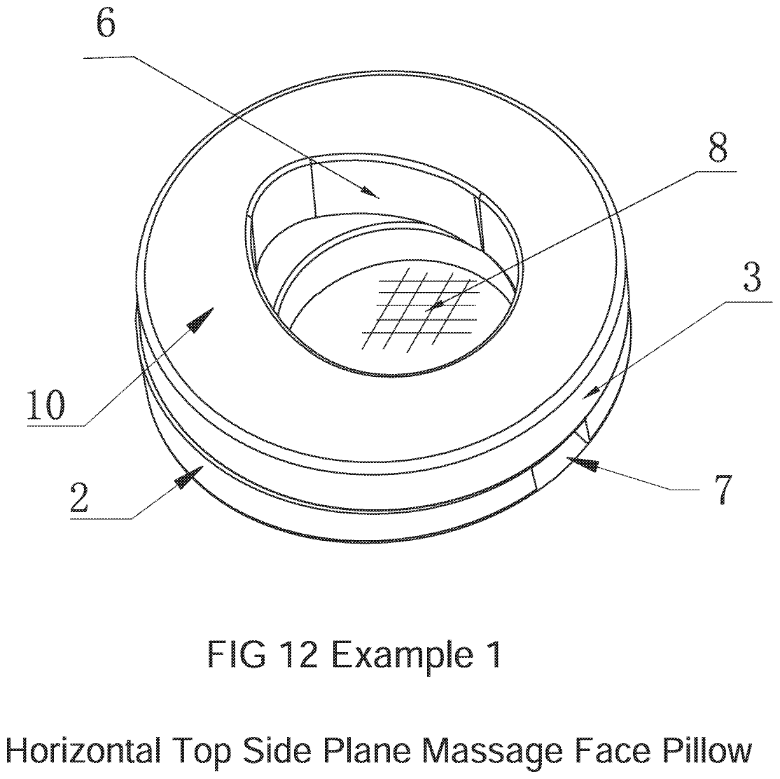

The Assembly of the three primary components results in example 1 of an independent massage face pillow with an internal sealed air channel. (FIG. 12). In this structure the breathing airflow travels from face-shaped hole (5) to round hole (4), and through horizontal rectangular air channel (44) before reaching the air outlet (7). The optimized low-height design makes it particularly suitable for massage and beauty treatments, eliminating the need for additional cradle or ventilation holes in massage tables, and also can be used on a soft massage mat.

### ADDITIONAL FEATURES

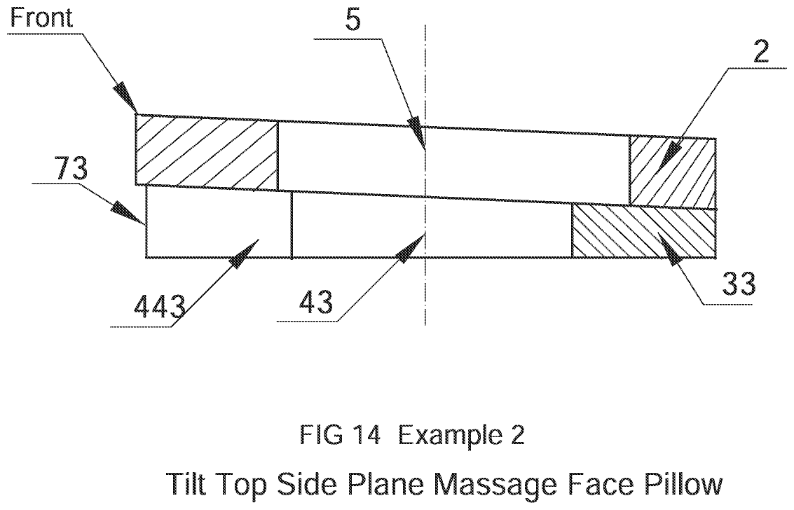

The top side plane of the lower Tier 2 Filler (3) can be slightly inclined (10-15 degrees) relative to the horizontal plane, which can further reduce the height of the massage face pillow backend. FIG. 14 illustrates Example 2 of this invention, showing an optimized internal airflow structure. The airflow travels from the face-shaped hole (5) to the round hole (43), then through the horizontal rectangular air channel (443) before reaching the air outlet (73). In this design, the back-end height of face pillow is lower compared to Example 1 in FIG. 12.

### BRIEF DESCRIPTION OF THE DRAWINGS

### FIGURES

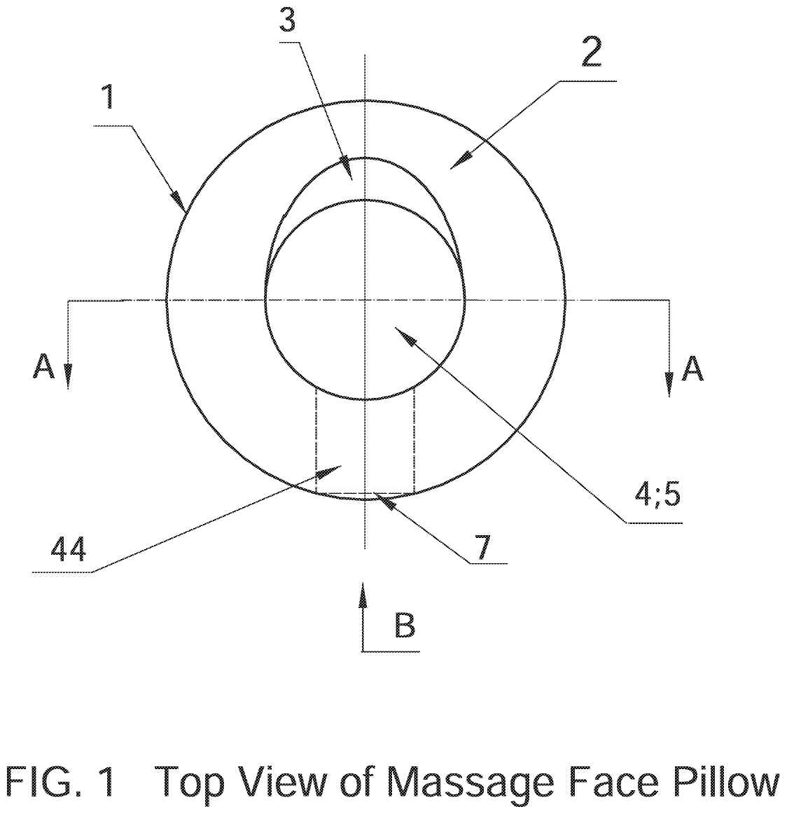

FIG. 1 Top View of Massage Face Pillow

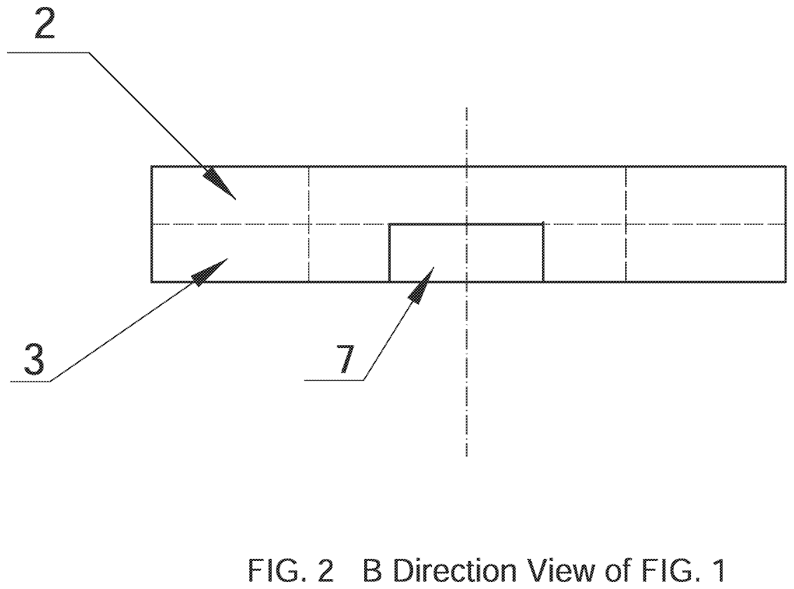

FIG. 2 B Direction View of FIG. 1

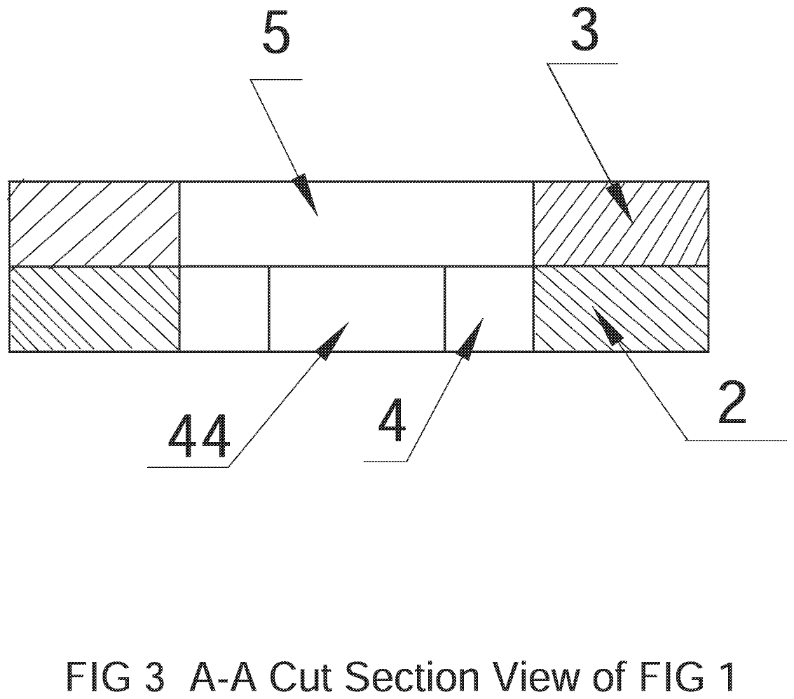

FIG. 3 A-A Cut Section View of FIG. 1

FIG. 4 Top View of Tier 1 Filler

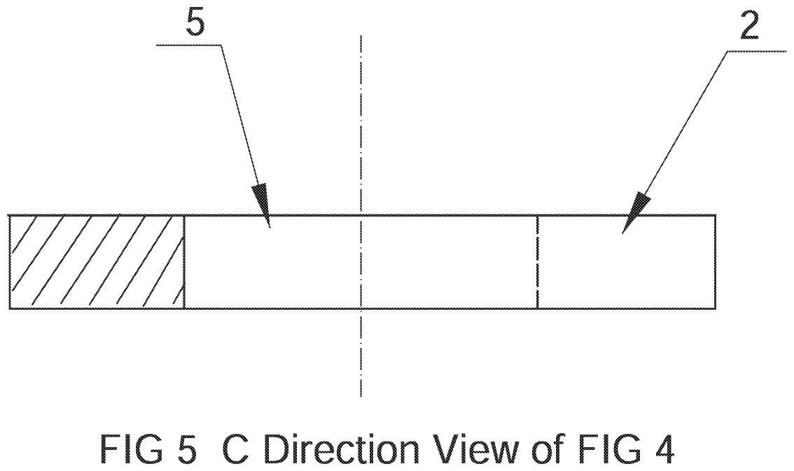

FIG. 5 C Direction View of FIG. 4

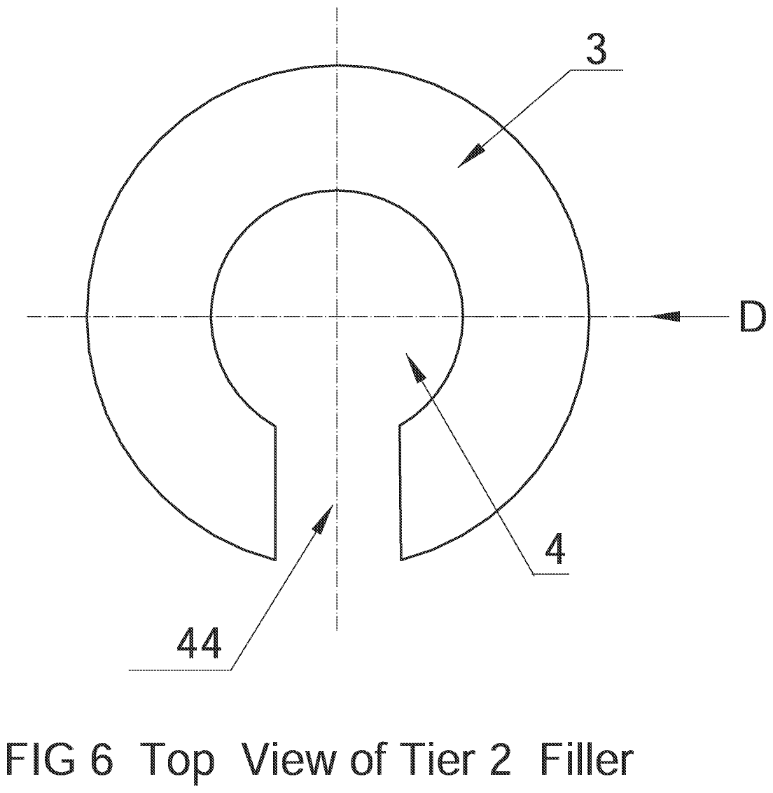

FIG. 6 Top View of Tier 2 Filler

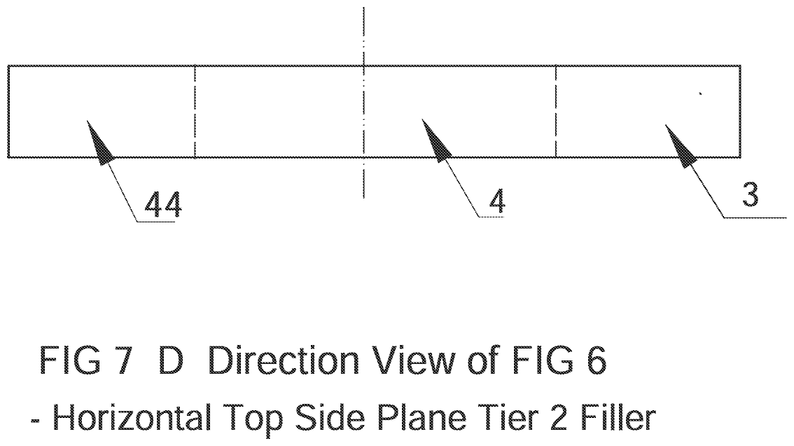

FIG. 7 D Direction View of FIG. 6-Horizontal Top Side Plane Tier 2 filler

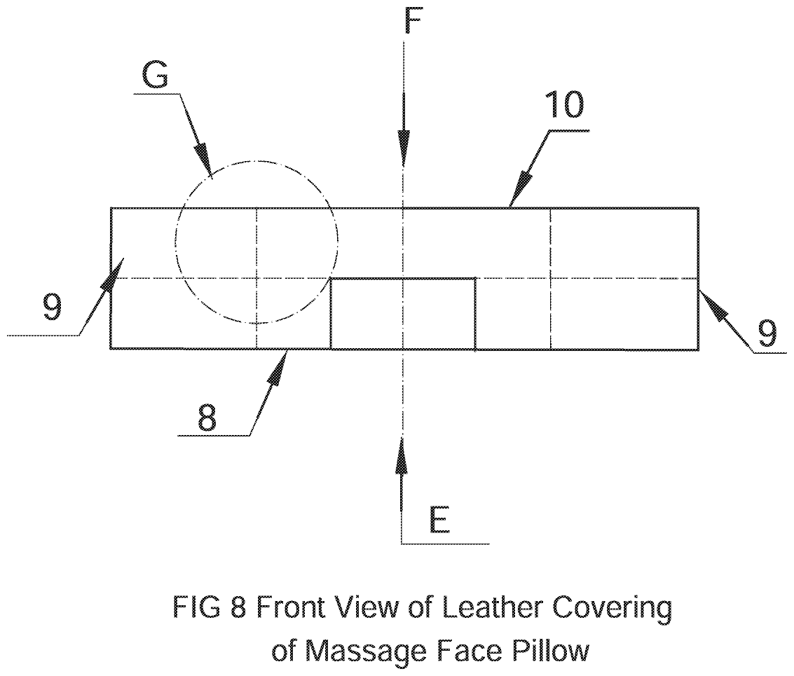

FIG. 8 Front View of Leather Covering of Massage Face Pillow

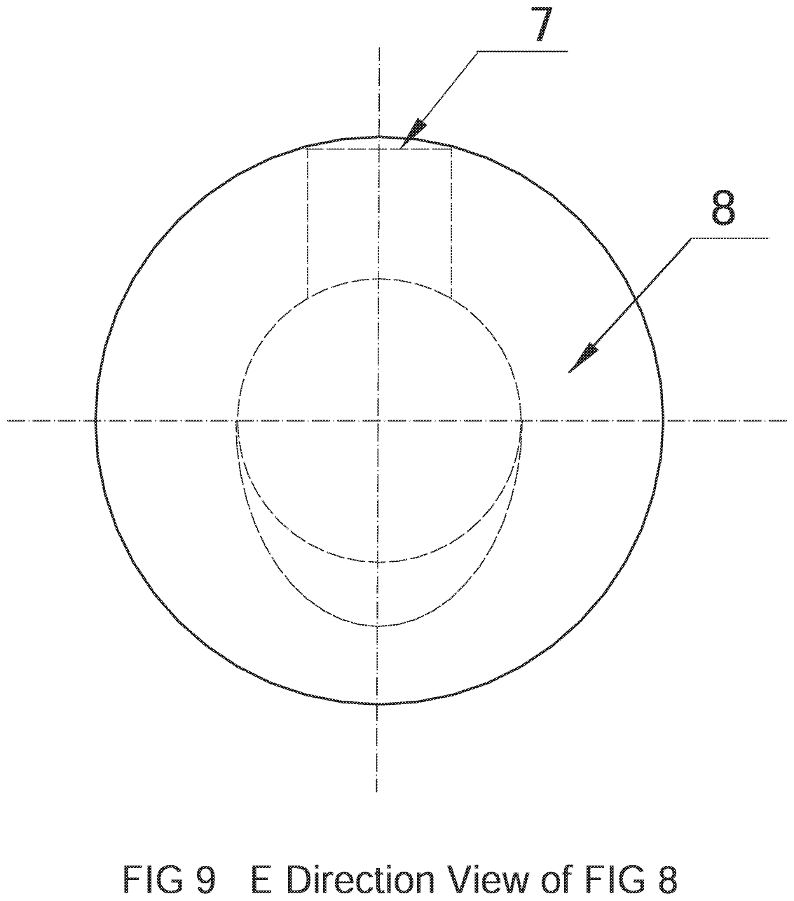

FIG. 9 E Direction View of FIG. 8

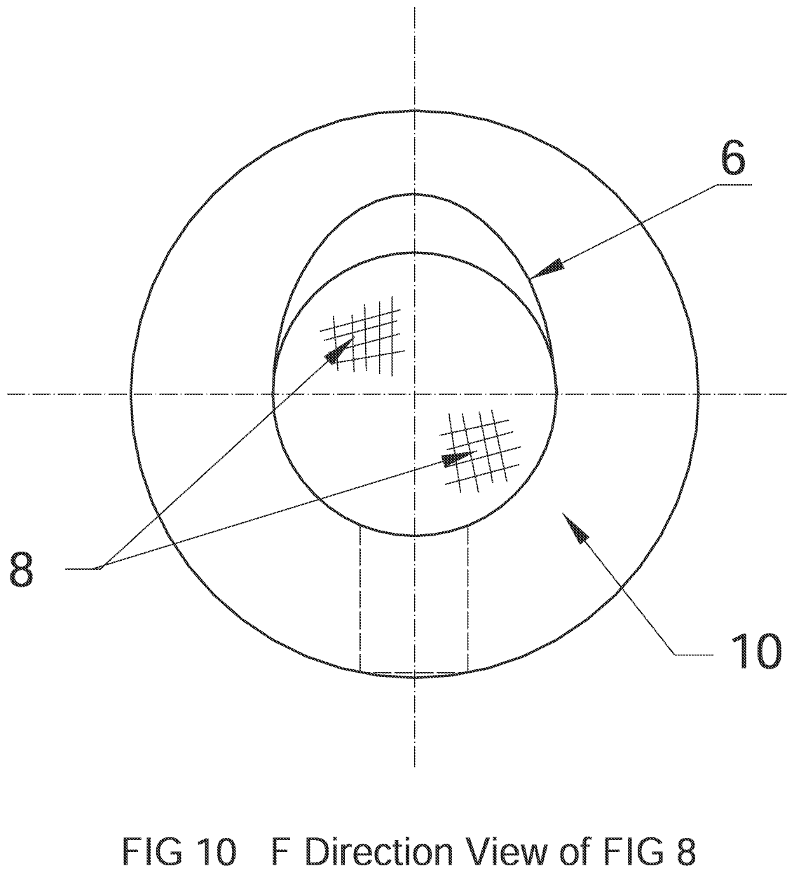

FIG. 10 F Direction View of FIG. 8

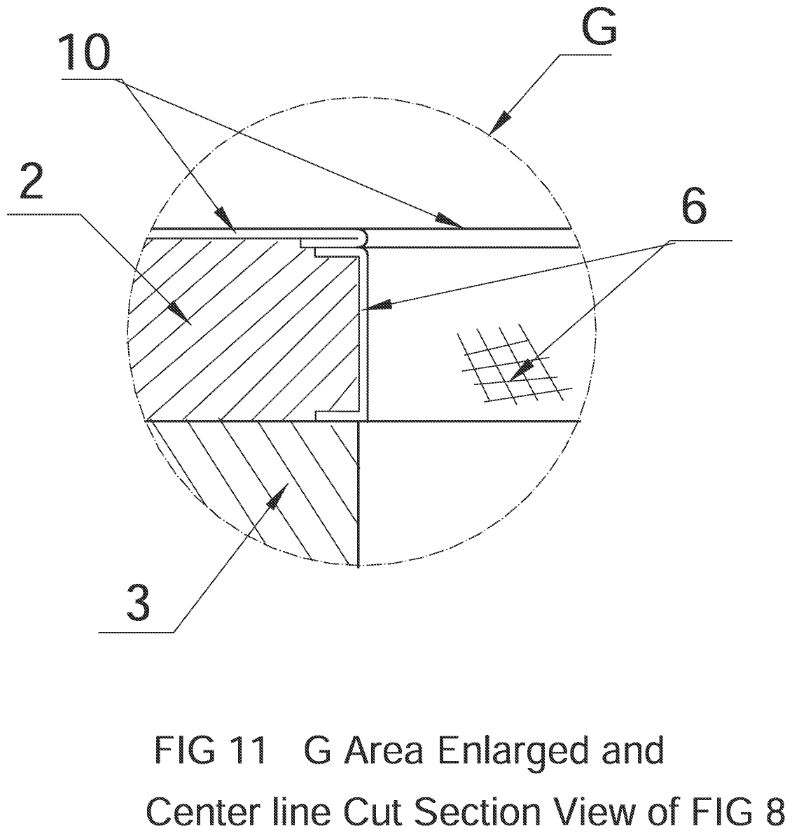

FIG. 11 G Area Enlarged and Center Line Cut Section View of FIG. 8

FIG. 12 Example 1: Horizontal Top Side Plane Massage Face Pillow

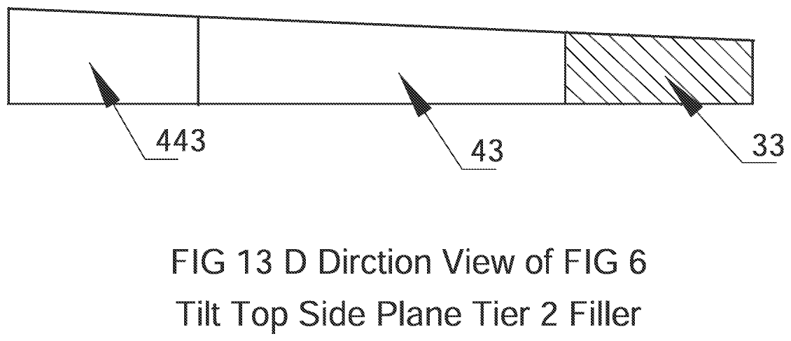

FIG. 13 D Direction View of FIG. 6-Tilt Top Side Plane Tier 2 Filler

FIG. 14 Example 2: Tilt Top Side Plane Massage Face Pillow

What is claimed is:

1. A massage face pillow with an internal air channel, comprising:
a). an upper Tier 1 filler (2) made of soft sponge material with a density of 25-35 kg/m³, having an outside diameter of approximately 11 inches and a face-shaped hole (5) in the center, adapted to fit the contours of a human face;
b) a lower Tier 2 filler (3) made of EPE foam material with a density of approximately 45kg/m³, positioned beneath the upper Tier 1 filler (2) and having a corresponding round hole (4) in the center, wherein the face-shaped hole (5) in the upper Tier 1 filler (2) aligns with the round hole (4) in the lower Tier 2 filler (3), forming a vertical breathing air channel that extends into a horizontal and rectangular air channel (44) in the front section of the lower Tier 2 filler (3), which ultimately connects to a front air outlet (7) at the front edge.
c). a leather covering (1) enclosing Tier 1 filler and Tier 2 filler, including
i. a bottom round piece (8) at the bottom side of Tier 2 filler (3),
ii. a vertical surrounding strip piece (9) with a front-facing open rectangular hole as an air outlet (7),
iii. a flat ring-shaped top piece (10) at the top side of the massage face pillow, and
iv. a hanging ring-shaped curtain piece (6) with top end connecting to the top piece (10) and lower end to being glued on the Tier 1 filler (2), covering the inside wall of face-shaped hole (5) in Tier 1 filler.

2. The massage face pillow with an internal air channel of claim 1, wherein the unique design of an internal air channel structure ensures that the breathing airflow travels from face-shaped hole (5) to round hole (4), and through horizontal rectangular air channel (44) to reach the air outlet (7) finally.

3. The massage face pillow with an internal air channel of claim 1, wherein the face-shaped hole (5) is initially formed as a round hole and later modified into a half round hole combining a half-oval hole to become face-adapted contour to enhance user comfort.

4. The massage face pillow with an internal air channel of claim 1, wherein the upper Tier 1 filler (2) and the lower Tier 2 filler (3), each has a thickness equal to approximately 50% of the total face pillow height.

5. The massage face pillow with an internal air channel of claim 1, wherein the front air outlet (7) has a width of approximately 2.5 inches and the height is the same as the thickness of Tier 2 filler (3) to optimize airflow.

6. The massage face pillow with an internal air channel of claim 1, wherein the lower Tier 2 filler (3) may have its top-side plane inclined at an angle of 10-15 degrees relative to the horizontal plane, further reducing the back-end height of the massage face pillow.
